(19) United States
(12) Patent Application Publication
(10) Pub. No.: US 2012/0274610 A1
(43) Pub. Date: Nov. 1, 2012

(54) INTERACTION SURFACES

(75) Inventor: Tobias Gulden DAHL, Oslo (NO)

(73) Assignee: ELLIPTIC LABORATORIES AS, Oslo (NO)

(21) Appl. No.: 13/458,740

(22) Filed: Apr. 27, 2012

(30) Foreign Application Priority Data
Apr. 27, 2011 (GB) GB1106971.3

(51) Int. Cl. G06F 3/043

(52) U.S. Cl. 345/177

(57) ABSTRACT

An input apparatus has an interaction surface, an acoustic transmitter located adjacent the surface, an acoustic receiver located adjacent the surface and across the surface from the transmitter, and a processing environment. It is configured to transmit an acoustic signal(s) from the transmitter and to receive the signal or signals at the receiver. It detects the presence of an input object adjacent or touching the interaction surface by detecting an increase in the minimum time of flight, through air, of at least a part of the signal(s).

This application takes priority from GB1106971.3 filed 27 Apr. 2011, the contents of which are incorporated by reference in its entirety.

### BACKGROUND OF THE INVENTION

1. Field of the Invention

The disclosed technology relates to touch and touchless interaction with an electronic device by a user.

2. Description of the Related Technology

Touch-screens and track-pads allow a user to provide input to an electronic device by contacting a stylus or finger onto an interaction surface.

Known touch-screens and track-pads do not, however, enable a user to interact with the device in proximity to (e.g. within a centimeter or so), but not touching, a surface. Such interaction is desirable in a wide range of contexts; for example, to activate a graphical user element as a user's finger approaches a display screen, or to avoid unhygienic contact with an interaction surface such as when controlling medical equipment in a surgical operating theatre.

It is known to detect the presence of an input object such as a finger proximate, but not touching, a surface by transmitting an ultrasound signal through air from transmitters positioned nearby the surface, and by receiving a reflection of the signal from the input object at ultrasound receivers positioned near the surface. By having a plurality of transmitters or receivers positioned around the screen it is possible to estimate the position of the object in space. Movement of the object may be used to interact with a device, for example by controlling an on-screen cursor or pointer. WO 2009/147398 (by the present applicant) describes some such arrangements.

However, the processing power required to detect and track an input object by trilateration using multiple transmitter-receiver pairs can be considerable. The applicant has realized that, in some situations, a simpler arrangement is desirable.

### SUMMARY OF CERTAIN INVENTIVE ASPECTS

A first aspect relates to an input apparatus comprising an interaction surface, an acoustic transmitter located adjacent the surface, an acoustic receiver located adjacent the surface and across the surface from the transmitter, and processing means, wherein the apparatus is configured to transmit an acoustic signal or signals from the transmitter, to receive the signal or signals at the receiver, and to detect the presence of an input object adjacent or touching the interaction surface by detecting an increase in the minimum time of flight, through air, of at least a part of the signal or signals.

One inventive aspect extends to a method for receiving a user input comprising transmitting an acoustic signal or signals from a transmitter located adjacent an interaction surface, receiving the signal or signals at a receiver located adjacent the interaction surface and across the surface from the transmitter, and detecting the presence of an input object adjacent or touching the interaction surface by detecting an increase in the minimum time of flight, through air, of at least a part of the signal or signals.

One inventive aspect also extends to computer software, and a carrier or signal bearing the same, which, when executed on processing means, causes the processing means to control an output to a transmitter located adjacent an interaction surface so as to cause the transmitter to transmit an acoustic signal or signals; to receive an input comprising the signal or signals received at a receiver located adjacent the interaction surface and across the surface from the transmitter; and to detect the presence of an input object adjacent or touching the interaction surface by detecting an increase in the minimum time of flight, through air, of at least a part of the signal or signals.

Diffraction of sound around an input object, e.g. a user's finger, will typically occur when the object is positioned in the path of sound travelling from the transmitter to the receiver, and that this effect can be detected and used to determine the presence of the object. Detecting an increase in the minimum time of flight can be done more efficiently than performing complex trilateration (ellipsoid-intersection) positioning operations. This is particularly advantageous when implemented on battery-powered mobile devices, such as mobile telephones, which typically have limited processing and energy resources.

The approach disclosed in one aspect may also be more accurate than known reflection-based positioning systems, whose accuracy can diminish as objects approach an interaction surface. This reduction in accuracy in known systems may arise due to directional characteristics of the transducers resulting in low signal strength close to the surface, or due to a shallower angle of incidence of the signal on the object resulting in a weaker reflection, or because ellipsoid intersection calculations are inherently inaccurate close to the plane of the transducers (where a small inaccuracy in a time of flight estimation can cause a tremendous impact in the position estimate, due to the ellipsoid surfaces being almost parallel).

Certain inventive aspects, by contrast, can support reliable detection of an input object in close proximity to, or touching, the interaction surface.

By detecting proximity to the surface, it can be possible to determine when an input object may be about to touch the surface. It may also be possible to determine reliably when the input object has just ceased touching the surface. Some known touch-screens are able to detect contact on the screen, but are poor at detecting when contact is subsequently broken (an “untouch” event), at least without expensive enhancements. In some applications, it may be useful to determine reliably when contact is lost, e.g. in order to deactivate a graphical element on the display screen. Certain embodiments of the present invention can provide a reliable and cost-effective way of determining “untouch” events.

The signal may be a continuous signal (i.e. continuously transmitted over a prolonged period, such as a second, or a minute or more) or the apparatus may be configured to transmit discrete signals (e.g. chirps) at regular or irregular intervals. The acoustic signal or signals are preferably ultrasonic signals. This can prevent annoyance to human users. However they could be subsonic or audible signals.

The minimum time of flight of all or part of the signal might be the difference between the time of transmission of the beginning, end or middle of the signal or part of the signal, and the time of arrival of the beginning or peak energy or peak intensity of the received signal or corresponding part thereof. However the minimum time of flight could be defined in any appropriate alternative manner. When energy or intensity levels are used, these might be determined based on instantaneous values (e.g. within the duration of one sample of an analogue-to-digital converter operating at a predetermined sampling rate), or over a predetermined time window, such as a sliding window, which could span several samples.

Peak energy or intensity might be determined in the raw signal domain or in the impulse response domain (e.g. if pulse compression is used or if impulse responses are continuously estimated). The apparatus may compute an envelope of the received signal and determine a peak energy or intensity in the envelope of the received signal.

In preferred embodiments, coded signals, such as ultrasonic chirps or pseudorandom codes, are transmitted at regular intervals and an impulse response is calculated in respect of each signal. In such embodiments, the minimum time of flight is preferably determined for the highest amplitude in the impulse response, or using a plurality of indices corresponding to the N highest amplitude values, for a suitable value of N (e.g. 2, 3, 5, 10 or more). By considering a plurality of highest amplitudes, allowance may be made of any distortion or artifacts in the impulse response, e.g. due to ringing effects.

An increase in the minimum time of flight might be determined by comparing the minimum times of flight determined in respect of two or more discrete signals, or in respect of corresponding parts of two more discrete signals; e.g. successive signals. Alternatively, it might be determined by comparing minimum times of flight for different parts of a continuous signal.

Preferred embodiments may retain a history of minimum times of flight for a number (e.g. 1, 2 or 5) of impulse responses corresponding to earlier signals. They may compare one or more subsequent minimum times of flight against historical times of flight to detect an increase. After an increase is detected, a decrease in the minimum time of flight may be detected.

The apparatus is preferably configured to detect the approach of the input object towards the interaction surface by detecting an increase or upward trend in the minimum time of flight, through air, of at least a part of the signal or signals. The apparatus may react to such a detection, e.g. by issuing an “approaching” or “touch” event to a software application.

The apparatus is preferably configured to detect the receding of the input object away from the interaction surface by detecting a decrease or downward trend in the minimum time of flight, through air, of at least a part of the signal or signals. The apparatus may react to such a detection, e.g. by issuing a “receding” or “untouch” event to a software application.

Some of the energy of a transmitted signal may be received along a direct path (ignoring any diffraction which may occur immediately adjacent the transmitter or receiver due to any apertures, waveguides, etc. which may be present), while some may be diffracted around the input object. The proportion of diffracted energy might typically be more than half of the total energy received at the receiver, but it could be less than half, for example when the input object only partially occludes the signal path between the transmitter and the receiver. In such instances, an increase in the minimum time of flight might be determined in respect of only parts of one or more signals.

The apparatus may be configured to ignore reflections of the transmitted signal, for example by discarding signals received beyond a time threshold after transmission of the signal.

The direct path of the signal will typically have non-trivial width and/or depth due to the physical dimensions of the transmitter (e.g. piezo-electric sounder) and/or receiver (e.g. microphone). The skilled person will appreciate that the dimensions of this path may be adjusted by choosing transducers having appropriate characteristics, or by the apparatus comprising suitable waveguides, reflectors, apertures, etc.

The transmitter/s and receiver/s may be situated such that their active surfaces touch the interaction surface, or they may be separated from it by an appropriate distance (e.g. spaced apart by up to about 1 mm, 5 mm, 1 cm, 10 cm or even more). It is advantageous for them to be located close to the surface, so as to avoid false detection of objects in the signal path but away from the interaction surface.

The input apparatus preferably comprises a plurality of acoustic transmitters and/or a plurality of acoustic receivers. A plurality of receivers may be located at regular or irregular intervals along an edge of the interaction surface; for example, along a straight edge of the surface. The apparatus may be configured to determine, for each receiver, whether or not an input object is located along a path between one or more of the transmitters and the receiver. The apparatus may thereby determine information relating to the position of the input object relative to the interaction surface.

In some preferred embodiments, the apparatus comprises receivers at intervals along a first axis and receivers at intervals along a second axis, preferably orthogonal to the first axis. Preferably the receivers of each set are spaced at respective uniform intervals. The apparatus may be configured to determine a Cartesian or pseudo-Cartesian coordinate for the input object by detecting the presence of the object in a path corresponding to a receiver along the first axis and in an orthogonal path corresponding to a receiver along the second axis. An input object may be detected by a plurality of receivers along an axis. In this case, one of detections may be determined to be the most significant according to a significance metric, such as the degree of increase in the minimum time of flight for that path. Alternatively, the apparatus may respond to all the detections, for example by determining a width of the input object.

A plurality of transmitters may be configured to transmit respective signals (which may be identical) substantially simultaneously. When configured to transmit simultaneously, the transmitters may be arranged such that a plane wave is transmitted, for example from a line of transmitters. A parallel line of receivers may receive respective portions of the plane wave.

The apparatus may comprise an elongate transmitter, such as a diaphragm or membrane or piezo-electric crystal which is two, five, ten or a hundred times longer than it is wide. The use of such a transducer may substantially reduce the overall system costs while still retaining the ability to detect and/or track objects close to the interaction surface. The apparatus may additionally or alternatively comprise an elongate receiver.

Alternatively, a plurality of transmitters may be configured to transmit respective signals at different times, e.g. one after another along a row of transmitters (time division multiplexing). An interval between respective transmissions may be such that receivers can discriminate between the different transmitted signals. The apparatus may additionally or alternatively use frequency or code division multiplexing to discriminate between different transmitters or transmit signals.

Each receiver may be paired with a specific transmitter. The apparatus may then be configured, for a given receiver, only to detect an input object using signals transmitted from the transmitter paired with the receiver. This could be achieved by using different codes, frequencies or other signal characteristics for different transmitters. The apparatus may have equal numbers of transmitters and receivers, although this is not essential even when pairing is used, since one transmitter or receiver may be paired with more than one receiver or transmitter.

The apparatus preferably comprises a transmitter/transmitters and receivers arranged so that direct signal paths therebetween provide substantially complete coverage of the interaction surface. In this way, the input object may be detected wherever it is, on or adjacent the surface. The transducers are preferably arranged so that every point on or adjacent the surface lies in the direct paths of at least two transmitter-receiver pairs. The input object may typically be considered adjacent the surface when it is within about 1, 2 or 5 millimeters of the surface. However, in some embodiments, it may be detected as adjacent the surface at greater distances, e.g. within about 1, 2 or 5 centimeters.

In this way it can be possible to pinpoint the location of the input object to within a required degree of accuracy. Coverage need not necessarily be comprehensive, so long as the maximum dimension of any region adjacent the surface which is not crossed by a signal path is less than the anticipated minimum dimension of the input object (e.g. less than 1 cm, 5 mm or 1 mm).

The interaction surface may form part of a display screen; for example, a liquid-crystal display panel. It may be curved or planar. In some embodiments it is a planar rectangle.

The input apparatus may be configured to determine an attenuation in at least a part of the received signal or signals caused by the presence of the input object in the signal path. It may use this determination of attenuation, or shadowing, for detecting the presence of the input object, in addition to using an increase in the minimum time of flight. The apparatus may be configured to detect the presence of the input object when it detects both attenuation (e.g. within a predetermined level) and an increase in time of flight occurring at the same time or within a common time window of predetermined duration, or it may be configured to detect the input object as present when either one or other of these effects is detected.

The apparatus may detect that the input object is actually touching the surface when attenuation is above a threshold level. It may respond appropriately to such detection, e.g. by issuing a “touch” event to a software application.

In some embodiments, the apparatus may also comprise conventional touch-screen or touch-pad technology for detecting contact between the input object and the surface. This combination may enhance the accuracy of the conventional technology, especially for detecting “untouch” events.

The input apparatus may be configured to respond to detecting the input object in any appropriate manner. For example, in response to the detection the apparatus may alter the content of a display screen—e.g. by moving an icon, pointer or cursor, scrolling on-screen items or moving a virtual control—or may communicate a signal to a remote device. Any response may further depend on information relating to the position of the input device relative to the interaction surface.

Of course, more than one input object may be detected simultaneously.

The processing means or processor may be any suitable computing device. It may comprise one or more general-purpose processors. It may additionally or alternatively comprise dedicated hardware logic and/or one or more DSPs and/or one or more FPGAs.

### BRIEF DESCRIPTION OF THE DRAWINGS

Certain embodiments of the invention will now be described, by way of example only, with reference to the accompanying drawings, in which:

FIG. 1 is a perspective drawing of a user interacting with a device in one embodiment;

FIG. 2 is a plot of impulse responses from signals received at a microphone of the device when no input object is present; and

FIG. 3 is a plot of impulse responses from signals received at the microphone when the user is interacting with the device.

### DETAILED DESCRIPTION OF CERTAIN ILLUSTRATIVE EMBODIMENTS

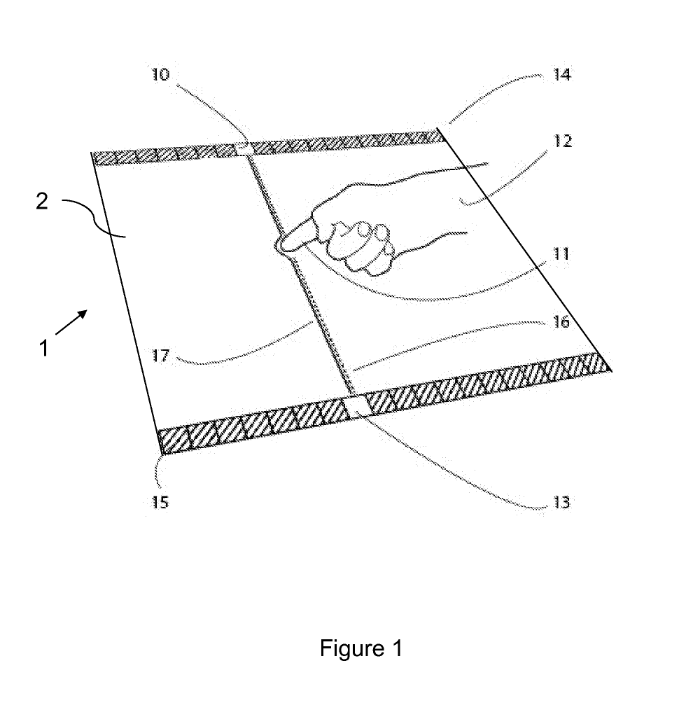

FIG. 1 shows part of a device 1 such as a mobile telephone having a rectangular display screen 2. A row of piezo-electric ultrasound transmitters 14 runs along the top edge of the display screen 2. A row of piezo-electric microphones 15 runs along the bottom edge of the display screen 2. There may be a further row of transmitters running up one edge of the screen 2, and a further row of microphones running up the other edge, but these are not shown here.

The device 1 contains logic (e.g., a processor running software) for transmitting signals from the transmitters 14 and for processing signals received from the microphones 15. For the purposes of illustrating its operation, one transmitter 10 of the device 1 is highlighted, along with a microphone 13 located directly across the screen 2 from the transmitter 10. A direct path between the transmitter 10 and the microphone 13 is indicated by a dashed line 16.

In operation the device 1 transmits one or more signals 17 (e.g. a succession of chirps or codes at regular intervals) from the transmitter 10. It may simultaneously transmit the same signal from the other transmitters 14, such that a plane wave travels across the screen 2, but this is not essential. When no input object is present, after a predictable time delay (e.g. a constant time delay, except for changes in atmospheric conditions), each signal is received at the microphone 13. The device processes the signal to obtain a channel impulse response, e.g. by applying a de-chirp operation, or signal decompression or deconvolution.

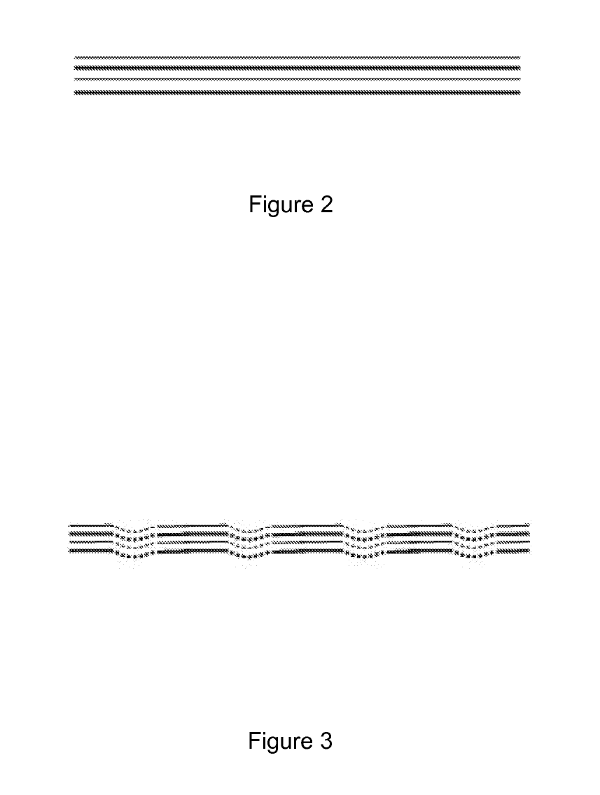

FIG. 2 shows a succession of channel impulse responses from signals received at receiver 13, represented as a horizontal array of vertical columns, with each column showing an impulse response over time with shades of grey indicating signal strength. In this example, no input object is present.

Techniques for generating and analyzing such channel impulse responses are described in the applicant's earlier patent applications, including WO 2006/067436, WO 2009/115799, WO 2009/147398 and WO 2011/036486, the contents of which are incorporated by reference in their entireties..

In FIG. 2, the horizontal lines collectively represent the direct-path signal from the transmitter 10 to the receiver 13. The multiple lines are due to ringing artifacts (in a theoretical perfect set up, only a single horizontal line would be present).

FIG. 3 shows the same situation, but here the finger 11 of the user's hand 12 is moved near to (e.g. 1 cm away from) the surface of the display screen 2 and then away from the surface. This is repeated a further three times within the time frame covered by the diagram in FIG. 3 (in which time from one impulse response to the next is represented left to right on the horizontal axis).

As can be seen from FIG. 3, when the finger 11 is close to the display screen, the signal is both attenuated (represented by a lighter shade of grey in the impulse response image), and delayed due to diffraction around the finger 11 (represented by a dip in the horizontal line). Note that higher positions on the vertical axis of the diagram represent later times within a single impulse response calculation; i.e. earlier-received signals.

The device 1 uses one or more analoge-to-digital converters as well as software running on its processing environment having one or more processors and one or more storage units for programs and data, or dedicated hardware logic (such as an application specific integrated circuit (ASIC) or field programmable gate array (FPGA)), or a digital signal processor (DSP) and associated software, or a combination of these, to process the received signals. The sampling rate should be sufficiently high as to provide enough resolution to detect changes in times of flight in the impulse responses. When the device 1 detects a delay in the peak amplitude, or in a characteristic amplitude pattern, in one impulse response compared with one or more earlier or immediately preceding impulse responses, it determines that the finger 11 is present and responds appropriately.

One or more digital-to-analogue and/or analogue-to-digital converters may be shared between multiple transmitters and/or receivers, e.g. using one of the approaches described in the applicant's prior filed patent application WO 2009/147398 referenced above.

The device 1 may be arranged to determine the approach of the finger 11 towards the screen 2 by detecting successive increases in the minimum time of flight; it may respond in a first manner. It may be arranged then to determine contact between the finger 11 and the screen 2 by detecting a maximum increase in the time of flight, which may be somewhat stable while contact is maintained; it may respond to this in a second manner. It may be arranged then to determine when the finger 11 leaves the screen 2 by detecting successive decreases in the minimum time of flight; it may respond to this in a third manner.

It will be seen that the arrangement described above with reference to the drawings gives a simple and cost-effective way of detecting when a user's finger is near to a screen but without requiring the screen actually to be touched. The respective rows of transmitters 14 and receivers 15 enable an estimate of the horizontal position of the finger to be made. It will be clearly appreciated that by arranging similar rows along the other two sides of the screen 2, a two-dimensional position can be estimated. The side transmitters may use a different code, different frequency or different timing to avoid interference.

It will also be appreciated that the signal attenuation described above can also be used to detect presence of the finger, e.g., to increase the reliability of the estimate made by measuring the effect of diffraction in increasing the minimum time of flight, or to aid in discriminating between an approaching finger, a static touching finger, a receding finger, and no finger.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. An input apparatus comprising:
an interaction surface;
an acoustic transmitter located adjacent the surface;
an acoustic receiver located adjacent the surface and across the surface from the transmitter; and
a processor,
wherein the apparatus is configured to:
transmit an acoustic signal or signals from the transmitter;
receive the signal or signals at the receiver; and
detect the presence of an input object adjacent or touching the interaction surface by detecting an increase in the minimum time of flight, through air, of at least a part of the signal or signals.

2. The input apparatus of claim 1, configured to transmit coded acoustic signals at regular intervals, and to calculate an impulse response in respect of each signal.

3. The input apparatus of claim 2, configured to determine the minimum time of flight for a signal using a plurality of indices corresponding to the N highest amplitude values in an impulse response calculated in respect of the signal.

4. The input apparatus of claim 1, configured to retain a history of minimum times of flight for a number of impulse responses corresponding to earlier signals and to compare one or more subsequent minimum times of flight against historical times of flight to detect an increase in the minimum time of flight.

5. The input apparatus of claim 1, configured to detect an approach of the input object towards the interaction surface by detecting an increase or upward trend in the minimum time of flight, through air, of at least a part of the signal or signals.

6. The input apparatus of claim 1, configured to detect a receding of the input object away from the interaction surface by detecting a decrease or downward trend in the minimum time of flight, through air, of at least a part of the signal or signals.

7. The input apparatus of claim 1, wherein the transmitter and receiver are situated such that their active surfaces are separated from the interaction surface by less than one centimeter.

8. The input apparatus of claim 1, comprising a plurality of receivers located at intervals along an edge of the interaction surface.

9. The input apparatus of claim 1, comprising a plurality of transmitters and a plurality of receivers, and being configured to determine, for each receiver, whether or not an input object is located along a path between one or more of the transmitters and the receiver.

10. The input apparatus of claim 1, comprising receivers at intervals along a first axis, and receivers at intervals along a second axis, orthogonal to the first axis, wherein the apparatus is configured to determine a Cartesian or pseudo-Cartesian coordinate for the input object by detecting the presence of the input object in a path corresponding to a receiver on the first axis and in an orthogonal path corresponding to a receiver on the second axis.

11. The input apparatus of claim 1, comprising a plurality of receivers along an axis, and wherein the apparatus is configured, if the input object is detected by more than one of the receivers, to determine one of the detections as the most significant detection according to a significance metric.

12. The input apparatus of claim 1, comprising a plurality of transmitters, and being configured to transmit a plane wave by transmitting respective signals from the transmitters substantially simultaneously.

13. The input apparatus of claim 12, wherein the plurality of transmitters are arranged in a line, and wherein the input apparatus comprises a parallel line of receivers arranged to receive respective portions of the plane wave.

14. The input apparatus of claim 1, wherein the acoustic transmitter and/or the acoustic receiver are elongate.

15. The input apparatus of claim 1, comprising a plurality of transmitters and a plurality of receivers, each receiver being paired with a transmitter, wherein the input apparatus is configured, for each receiver, to detect the input object using only signals transmitted from the transmitter paired with the receiver.

16. The input apparatus of claim 1, comprising a plurality of receivers, wherein the receivers and one or more transmitters are arranged so that every point on or adjacent the interaction surface lies in the direct paths of at least two transmitter-receiver pairs.

17. The input apparatus of claim 1, further configured to detect the presence of the input object by determining an attenuation in at least a part of the received signal or signals, caused by the presence of the input object in the signal path.

18. The input apparatus of claim 17, configured to detect that the input object is touching the interaction surface when the attenuation is above a threshold level.

19. The input apparatus of claim 1, configured to respond to detecting the presence of the input object, wherein the response is dependent on information relating to the position of the input object relative to the interaction surface.

20. The input apparatus of claim 1, wherein the interaction surface forms part of a display screen.

21. A method of receiving a user input, the method comprising:
transmitting an acoustic signal from a transmitter located adjacent an interaction surface;
receiving the signal at a receiver located adjacent the interaction surface and across the surface from the transmitter; and
detecting the presence of an input object adjacent or touching the interaction surface by detecting an increase in the minimum time of flight, through air, of at least a part of the signal.

22. The method of claim 21, further comprising retaining a history of minimum times of flight for a number of impulse responses corresponding to earlier signals and detecting an increase in the minimum time of flight by comparing one or more later minimum times of flight against historical times of flight.

23. The method of claim 21, further comprising detecting a receding of the input object away from the interaction surface by detecting a decrease or downward trend in the minimum time of flight, through air, of at least a part of the signal.

24. The method of claim 21, further comprising determining, for each of a plurality of receivers, whether or not an input object is located along a path between the receiver and one or more of a plurality of transmitters.

25. The method of claim 21, further comprising determining a Cartesian or pseudo-Cartesian coordinate for the input object by detecting the presence of the input object in a path corresponding to one of a plurality of receivers located at intervals along a first axis and in an orthogonal path corresponding to one of a plurality of receivers located at intervals along a second axis, orthogonal to the first axis.

26. The method of claim 21, further comprising detecting the presence of the input object by determining an attenuation in at least a part of the received signal, caused by the presence of the input object in the signal path.

27. The method of claim 26, comprising detecting that the input object is touching the interaction surface by determining that the attenuation is above a threshold level.

28. The method of claim 21, comprising responding to detecting the presence of the input object with a response that is dependent on the position of the input object relative to the interaction surface.

29. A non-transitory computer-readable medium having stored thereon computer software which, when executed on a processor, causes the processor to:
control an output to a transmitter located adjacent an interaction surface so as to cause the transmitter to transmit an acoustic signal;
receive an input comprising the signal received at a receiver located adjacent the interaction surface and across the surface from the transmitter; and
detect the presence of an input object adjacent or touching the interaction surface by detecting an increase in the minimum time of flight, through air, of at least a part of the signal.
